(19) United States
(12) Patent Application Publication
(10) Pub. No.: US 2008/0140869 A1
(43) Pub. Date: Jun. 12, 2008

(54) Circuits and Methods for Correcting Errors in Downloading Firmware

(76) Inventor: Nam-Phil Jo, Seoul (KR)

Correspondence Address: MYERS BIGEL SIBLEY & SAJOVEC, PO BOX 37428, RALEIGH, NC, 27627, US

(21) Appl. No.: 11/737,281

(22) Filed: Apr. 19, 2007

(30) Foreign Application Priority Data
Dec. 11, 2006 (KR) 2006-125739

(51) Int. Cl. G06F 3/00

(52) U.S. Cl. 710/8

(57) ABSTRACT

An electronic device operating using firmware can include a nonvolatile memory and an interface circuit that is configured to receive a firmware data signal transmission from external to the electronic device, where the firmware data signal includes error correction codes. An error correction circuit is coupled to the interface circuit and to the nonvolatile memory, and is configured to repair errors introduced into the firmware data signal during transmission of the firmware data signal to provide a corrected firmware data signal at the electronic device and to store the corrected firmware data signal in the nonvolatile memory.

### CROSS-REFERENCE TO RELATED APPLICATION

This U.S. non-provisional patent application claims priority under 35 U.S.C. § 119 of Korean Patent Application No. 2006-125739 filed on Dec. 11, 2006, the entire content of which is hereby incorporated herein by reference.

### FIELD OF THE INVENTION

The present invention disclosed herein relates to the field of electronics, and more particularly, to electronic devices having firmware.

### BACKGROUND

Firmware means a micro-program stored in a memory such as a read-only memory (ROM), controlling hardware. Being even regarded as same with software in the point that firmware is also a kind of program, it may be said that the firmware has all characteristics of software and hardware, differentiated from general application software, since it is closely relevant to hardware.

In constructing hardware for a specific function, a full hardware structure for all circuits may cause increased complexity in architecture and may even call for parts that are hard to be represented in logical patterns.

In this case, by organizing a storage unit, which contains software, as the core in control circuits of hardware while replacing considerable parts with the software, it is possible to address the above problems while also maintaining a low cost. Such hardware software made thereby is referred to as firmware.

Usually, electronic devices, such as MP3, memory stick, MultiMedia card (MMC), digital versatile disc (DVD) player, mobile phone, and so forth, are manufactured by including basic firmware by makers. Upgrading firmware may be used to add new functions to an electronic device, to fix a firmware bug, or to alter or enhance existing functions.

As is well known, in order to upgrade firmware, it needs to connect an electronic device with a host such as computer system in a wired or wireless mode, and download new firmware. However, if a network connecting the host to the electronic device is unstable or errors are otherwise introduced into the firmware due to malfunctions of the host system, erroneous firmware may be downloaded into the electronic device which may damage or otherwise affect the operation of the electronic device.

### SUMMARY

An electronic device operating using firmware can include a nonvolatile memory and an interface circuit that is configured to receive a firmware data signal transmission from external to the electronic device, where the firmware data signal includes error correction codes. An error correction circuit is coupled to the interface circuit and to the nonvolatile memory, and is configured to repair errors introduced into the firmware data signal during transmission of the firmware data signal to provide a corrected firmware data signal at the electronic device and to store the corrected firmware data signal in the nonvolatile memory.

In some embodiments according to the invention, an electronic device operating using firmware includes an error correction circuit that is configured to repair errors introduced into a firmware data signal during transmission of the firmware data signal over a network to provide a corrected firmware data signal at the electronic device and to store the corrected firmware data signal in the nonvolatile memory, where the firmware data signal includes both error correction code bits and cyclic redundancy check bits.

In some embodiments according to the invention, the error correction code bits and cyclic redundancy check bits are both included in packets according to which the firmware data signal is received. In some embodiments according to the invention, the error correction circuit further includes a syndrome generator circuit, a key equation solver circuit coupled to the syndrome generator circuit, a Chien search error evaluator circuit coupled to the key equation solver circuit, and an error corrector circuit coupled to the Chien search error evaluator circuit.

In some embodiments according to the invention, a method of updating firmware stored in a nonvolatile memory of an electronic device includes receiving a firmware data signal including error correction check code bits, determining that the firmware data signal includes a correctable error, correcting the correctable error included in the firmware data signal to provide a corrected firmware data signal, and storing the corrected firmware data signal in the nonvolatile memory.

In some embodiments according to the invention, the firmware data signal includes both error correction code bits and cyclic redundancy check bits. In some embodiments according to the invention, data and the error correction code bits included in the corrected firmware data signal fit within one sector sized amount of data used to program the non-volatile memory.

In some embodiments according to the invention, a firmware downloading system includes a host system that is configured to transfer a firmware data signal that includes an error correction code and an electronic device that is configured to receive the firmware data signal from the host system. The electronic device can includes a nonvolatile memory and an interface circuit that is configured to receive a firmware data signal transmission from external to the electronic device, where the firmware data signal includes error correction codes. An error correction circuit is coupled to the interface circuit and to the nonvolatile memory, and is configured to repair errors introduced into the firmware data signal during transmission of the firmware data signal to provide a corrected firmware data signal at the electronic device and to store the corrected firmware data signal in the nonvolatile memory.

### BRIEF DESCRIPTION OF THE DRAWINGS

Non-limiting and non-exhaustive embodiments of the present invention will be described with reference to the following figures, wherein like reference numerals refer to like parts throughout the various figures unless otherwise specified. In the figures:

FIG. 1 is a block diagram illustrating a firmware downloading system in some embodiments according to the present invention.

FIG. 2 shows a conventional format of firmware data packet including CRC bits.

FIG. 3 shows a format of firmware data packet including CRC bits and error correction code bits transferred from the host in some embodiments according to the present invention.

FIG. 4 is a block diagram illustrating an internal circuit structure of an electronic device in some embodiments according to the present invention.

### DESCRIPTION OF EMBODIMENTS ACCORDING TO THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

FIG. 1 is a block diagram illustrating a firmware downloading system in some embodiments according to the present invention. Referring to FIG. 1, the firmware downloading system includes a host 100 and an electronic device 200. The electronic device 200 downloads firmware 202 from the host 100 over a communication network in order to upgrade the firmware 202. In some embodiments according to the present invention, the electronic device 200 can be a personal computer, a personal data assistant (PDA), a digital camera, an MP3 player, or a DVD player, or the like. The electronic device 200 can also include a memory card interface to enable an external memory card to be used with the electronic device 200 The memory card available in the electronic device 200 is a storage medium that can store voice or motion picture data to be played, for example, on a portable digital apparatus such as a mobile phone or a PDA. The memory card may be a Smart Media card, a Compact Flash card, a memory stick, a Secure Digital (SD) card, or the like. But, the present invention may be applicable to other devices or apparatuses able to download firmware from the host, not restrictive to the electronic digital products and the memory cards.

The host 100 can be connected with the electronic device 200 via communications network 110 through a connector, in a wired mode via, for example, to the Internet or other network. In some embodiments according to the present invention, host 100 can be connected with the electronic device 200 wirelessly.

The host 100, according to some embodiments of the present invention, transfers a firmware data signal, which contains an error correction code (ECC), to the electronic device 200. After receiving a firmware data signal containing an ECC, the electronic device 200 can repair errors included in or introduced into the firmware data signal and stores the corrected firmware data signal in a nonvolatile memory (not shown).

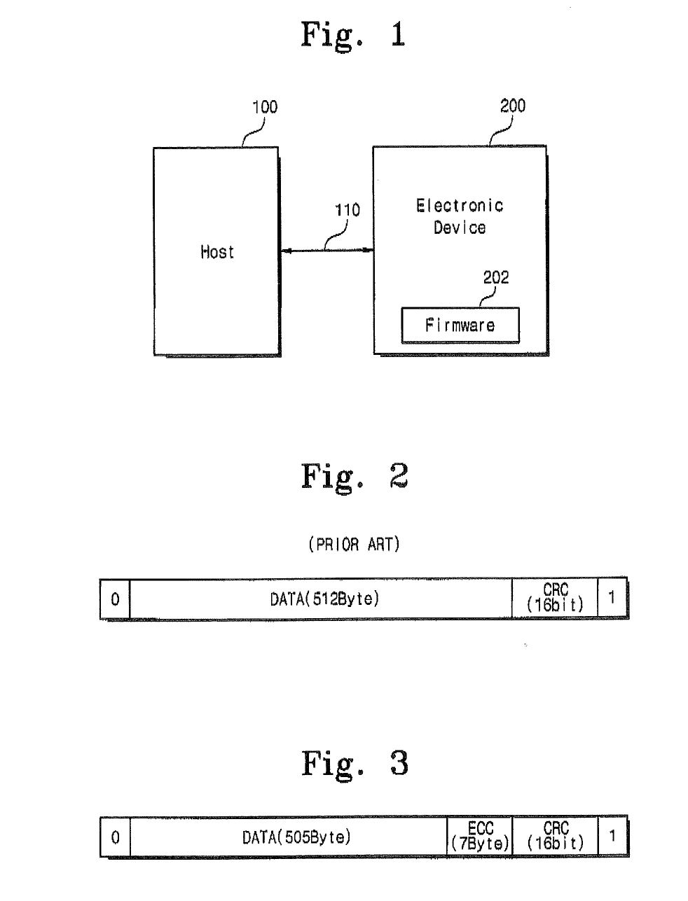

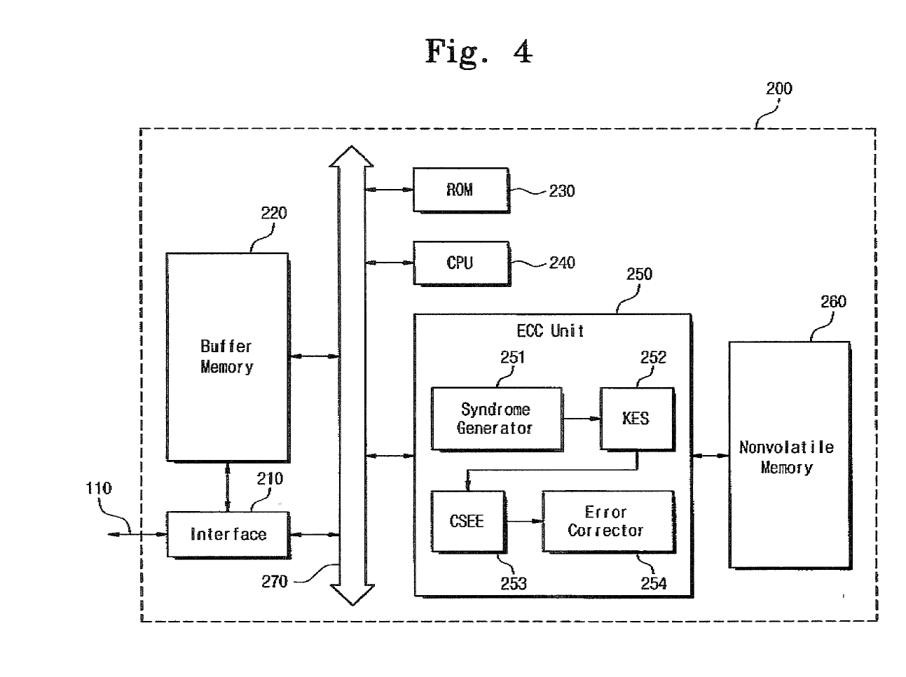

FIG. 2 shows a format of firmware data packet, and FIG. 3 (in contrast) shows a format of firmware data packet including ECC and CRC bits transferred from the host 100 in some embodiments of the present invention. A general format of firmware data packet includes 512-bytes data and 16-bytes of cyclic redundancy check (CRC) data. The CRC data uses a cyclic binary code that can be used to detect errors introduced during the transmission of the firmware data signal over the network 110. This way of CRC error check proceeds such that a transmittal site transfers data, which are divided in blocks each of which is followed by a cyclic sign obtained from a calculation with a binary polynomial and a reception site finds a transmittal error by whether the received data results in the same cyclic sign by the same calculation. Although the CRC scheme described above may detect certain errors introduced to during transmission, the CRC scheme may not have the capability to actually correct the detected errors.

In some embodiments according to the invention, the host 100 transfers a firmware data signal containing an ECC that can be used for repairing an error. The electronic device 100 can use the CRC bits to detect an error in the firmware data signal and then decode the ECC bits to correct the detected error(s).

FIG. 4 is a block diagram illustrating an internal circuit structure of the electronic device 200 in some embodiments according to the invention. Referring to FIG. 4, the electronic device 200 includes an interface 210, a buffer memory 220, a read-only memory (ROM) 230, a central processing unit (CPU) 240, an ECC unit 250, a nonvolatile memory 260, and a bus 270.

The interface 210 is connected to the host shown in FIG. 1 by way of the communication network 110. The interface 210 can detect errors in the data signal using the CRC code included in firmware data packets received from the host 100. The interface 210 stores a series of firmware data signals, which are transferred from the host 100, into the buffer memory 220. The firmware data signals stored in the buffer memory 220 through the interface 210 includes 512 bytes, i.e., one sector, including 505-byte data signals and a 7-byte ECC code. While this embodiment is described such that one sector is 512 bytes, the size of one sector can be any size, which can be based on, for example, the memory architecture.

The buffer memory 220 includes a plurality of sectors (not shown). The firmware data signals input from the interface 210 are stored in the buffer memory 220 in one sector sized units. The CPU 240 reads out the firmware data signals from the buffer memory 220 and provides the read firmware data signals to the ECC unit 250.

The ECC unit 250 is comprised of a syndrome generator 251, key equation solver (KES) 252, the Chien search error evaluator (CSEE) 253, and an error corrector 254. The syndrome generator 251 calculates syndromes of the firmware data signals using, for example, a Horner algorithm. The calculated syndromes are provided to the KES 252. The KES 252 obtains coefficients of error location and magnitude polynomials from the received syndromes. As well known, the KES 252 calculates the coefficients by means of the Berlekamp-Massey algorithm or the Euclid algorithm. The calculated coefficients are provided to the CSEE 253. The CSEE 253 evaluates an error position and value on basis of the error position and magnitude polynomials. The error position and value is transferred to the error corrector 254 and used for correction of the encoded firmware data signal.

A data signal output from the error corrector 254 is an error-corrected firmware data signal, including 505-byte data transferred from the host 100 and 7-byte null data. The null data may be set on ‘FFFFFFF’ or ‘0000000’ as an example. The firmware data signal with 512 bytes output from the error corrector 254 is stored in the nonvolatile memory 260. In some embodiments credit to the invention, the nonvolatile memory 260 is a kind of flash memory. Then, the CPU 240 can identify and utilize the non-null data included in the 512 bytes (i.e., the 505 bytes in the 1-sector) provided by the firmware data signal stored in the nonvolatile memory 260.

The ROM 230 stores the firmware used to operate the electronic device 200. The firmware for various applications of the electronic device 200 is stored in the nonvolatile memory 260. The firmware stored in the nonvolatile memory 260 may be upgraded in accordance with convenience of a user and new firmware is downloaded from the host 100.

In some embodiments according to the invention, the host 100 provides the electronic device 200 with packets of the firmware data signals including ECCs. The electronic device 200 detects an error in the firmware data signal packets by analyzing the ECCs, and can then correct the detected error, thereby allowing enhanced integrity of the firmware downloaded into the electronic device 200.

Referring to FIG. 4, in some embodiments according to the invention, data transferred from the host system is received by the interface circuit 210. The interface circuit 210 can detect errors in the firmware data signal using the CRC codes that are included therein. In some embodiments according to the invention, the interface circuit 210 stores the data and the ECC codes in the buffer memory 220, but does not store the CRC bits in the buffer memory 220. The interface circuit 210 can signal the CPU 240 to read the firmware data signals stored in the buffer memory 220 which are then provided to the ECC unit 250. The ECC unit 250 can then utilize the ECC codes to determine whether the error detected by the CRC codes is correctable. If the error is correctable, the ECC unit 250 corrects the data errors to provide a 505 byte data word along with seven bytes of null data to be stored as a 512 word in the nonvolatile memory 260.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An electronic device operating using firmware, the device comprising:
a nonvolatile memory;
an interface circuit configured to receive a firmware data signal transmission from external to the electronic device, the firmware data signal including error correction codes; and
an error correction circuit, coupled to the interface circuit and to the nonvolatile memory, being configured to repair errors introduced into the firmware data signal during transmission of the firmware data signal to provide a corrected firmware data signal at the electronic device and to store the corrected firmware data signal in the nonvolatile memory.

2. The electronic device as set forth in claim 1, further comprising:
a buffer circuit configured to temporarily store the firmware data signal received via the interface.

3. The electronic device as set forth in claim 2, further comprising:
a central processing unit configured to coordinate operation of the error correction circuit to repair errors included in the firmware data signal stored in the buffer, and to store the corrected firmware data signal in the nonvolatile memory.

4. The electronic device as set forth in claim 1, wherein the nonvolatile memory comprises flash memory.

5. The electronic device as set forth in claim 1, wherein a packet of the firmware data signal received includes data, error correction code bits, and cyclic redundancy check bits.

6. The electronic device as set forth in claim 5, wherein the data and error correction code bits fit within one sector sized amount of data used to program the non-volatile memory.

7. The electronic device as set forth in claim 6, wherein the corrected firmware data signal includes null data configured to replace the error correction code bits configured to fit within one sector sized amount of data used to program the non-volatile memory.

8. A firmware downloading system comprising:
a host system configured to transfer a firmware data signal that includes an error correction code; and
an electronic device configured to receive the firmware data signal from the host system, wherein the electronic device comprises:
a nonvolatile memory;
an interface circuit configured to receive a firmware data signal transmission from external to the electronic device, the firmware data signal including error correction codes; and
an error correction circuit, coupled to the interface circuit and to the nonvolatile memory, being configured to repair errors introduced into the firmware data signal during transmission of the firmware data signal to provide a corrected firmware data signal at the electronic device and to store the corrected firmware data signal in the nonvolatile memory.

9. The firmware downloading system as set forth in claim 8, wherein the electronic device comprises a non-volatile memory card.

10. The firmware downloading system as set forth in claim 8, wherein a packet of the firmware data signal received includes data, error correction code bits, and cyclic redundancy check bits.

11. The firmware downloading system as set forth in claim 10, wherein the data and error correction code bits fit within one sector sized amount of data used to program the non-volatile memory.

12. The firmware downloading system as set forth in claim 11, wherein the corrected firmware data signal includes null data configured to replace the error correction code bits configured to fit within one sector sized amount of data used to program the non-volatile memory.

13. An electronic device operating using firmware, the device comprising:
an error correction circuit configured to repair errors introduced into a firmware data signal during transmission of the firmware data signal over a network to provide a corrected firmware data signal at the electronic device and to store the corrected firmware data signal in the nonvolatile memory, wherein the firmware data signal includes both error correction code bits and cyclic redundancy check bits.

14. The electronic device as set forth in claim 13, wherein the error correction code bits and cyclic redundancy check bits are both included in packets according to which the firmware data signal is received.

15. The electronic device as set forth in claim 13, wherein the error correction circuit further comprises:
a syndrome generator circuit;
a key equation solver circuit coupled to the syndrome generator circuit;
a Chien search error evaluator circuit coupled to the key equation solver circuit; and
an error corrector circuit coupled to the Chien search error evaluator circuit.

16. A method of updating firmware stored in a nonvolatile memory of an electronic device, the method comprising:
receiving a firmware data signal including error correction check code bits;
determining that the firmware data signal includes a correctable error;
correcting the correctable error included in the firmware data signal to provide a corrected firmware data signal; and
storing the corrected firmware data signal in the nonvolatile memory.

17. The method as set forth in claim 16, wherein the firmware data signal includes both error correction code bits and cyclic redundancy check bits, the method further comprising:
detecting the correctable error using the cyclic redundancy check bits; and
then correcting the correctable error using error correction check code bits.

18. The method as set forth in claim 17, wherein data and the error correction code bits included in the corrected firmware data signal fit within one sector sized amount of data used to program the non-volatile memory.
